(19) United States
(12) Patent Application Publication
(10) Pub. No.: US 2008/0049330 A1
(43) Pub. Date: Feb. 28, 2008

(54) LIGHT DIRECTING LAMINATE

(75) Inventors: William A. Tolbert, Woodbury, MN (US); James M. Nelson, Lino Lakes, MN (US); Thomas A. Isberg, Minneapolis, MN (US); Andrew L. Hightower, Eden Prairie, MN (US); Dean Faklis, Bloomfield, NY (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/467,331

(22) Filed: Aug. 25, 2006

(51) Int. Cl. G02B 5/02

(52) U.S. Cl. 359/599

(57) ABSTRACT

A light management film package includes a first optical film having a structured surface and a second major surface, a second optical film having a first major surface and a second major surface disposed adjacent to and making contact with the structured surface of the first optical film via an adhesive layer. The structured surface of the first optical film includes a plurality of tall structures separated by short structures with the tops of neighboring tall structures separated by a distance of between about 50 and about 150 microns. The tall structures of the first optical film penetrate the adhesive layer, but the short structures do not.

### BACKGROUND OF THE INVENTION

The present invention relates to light directing films for optical displays. More particularly, the present invention relates to a light directing film having a structured surface with tall structures separated by short structures such that a distance between neighboring tall structures is in a specific range to maximize gain and minimize visible wet out.

Optical displays, such as liquid crystal displays (LCDs) are becoming increasingly commonplace, finding use, for example, in cellular phones, hand-held computer devices ranging from personal digital assistants (PDAs) to electronic games, to larger devices such as laptop computers, and LCD monitors and television screens. Light directing films are used to increase the luminance of light exiting an optical display in a preferred direction, typically normal, or “on-axis”, to the surface of the display.

The 3M brand Brightness Enhancement Film (BEF) from Minnesota Mining and Manufacturing (3M) Company is typically used to increase on-axis luminance. The film effectively collects light from “off-axis” and redirects this light on-axis toward the viewer. Thus the film increases the on-axis luminance at the expense of off-axis luminance. Gain is a measurement of the on-axis intensity with the film, or films, compared to the on-axis intensity without the film(s).

BEF films typically include a substantially planar surface and an opposing structured surface, which has an array of linear prismatic elements. The structured surface helps direct light along the viewing axis, thus enhancing the brightness of the light perceived by the viewer. Increasing the amount of on-axis light reduces the amount of energy required to generate a designed amount of on-axis luminance. This is particularly important for optical displays that use battery powered light sources such as those used in laptop computers, calculators, digital wristwatches, cellular phones, LCD TVs, and PDAs.

On the structured surface of the film, the sides of each prism element intersect to form a peak or apex. The peak of the prism element is usually sharp.

In an optical system, a structured light directing film may be placed closely adjacent to another film, such as another light directing film. Contact between the two films can result in visibly apparent and undesirable bright spots, streaks, or lines, often referred to as “wet out.” Wet out can also reduce gain.

### BRIEF SUMMARY OF THE INVENTION

The present invention relates to light management films.

In one embodiment of the invention, a light management film package includes a first optical film having a first major structured surface with a plurality of tall structures separated by short structures and a second major surface opposite the first major structured surface, where each tall structure and each short structure has a top and a height measured from the top to a first common reference plane. The height of each short structure is less than the height of each tall structure. The tops of neighboring tall structures are separated by a distance of between about 50 and about 150 microns. The light management film package further includes a second optical film having a first major surface and a second major surface opposite the first major surface, where the second major surface is disposed adjacent to and makes contact with the first major structured surface of the first optical film via an adhesive layer. Each tall structure of the first optical film penetrates the adhesive layer and the short structures of the first optical film do not penetrate the adhesive layer.

In another embodiment of the invention, a laminated film package includes a first light directing film that includes a first smooth surface and a first structured surface opposite the first smooth surface and having an array of tall prisms separated by short prisms. A first common reference plane is disposed between the first smooth surface and the first structured surface without passing through the array of tall prisms and short prisms. Each prism has a top and a height measured from the top to the first common reference plane. The height of each tall prism is greater than the height of each short prism. A distance between the tops of each neighboring tall prisms is between about 50 and about 150 microns. The laminated film package further includes a second light directing film that includes a second smooth surface and a second structured surface opposite the second smooth surface and having an array of prisms. A second common reference plane is disposed between the second smooth surface and the second structured surface without passing through the array of prisms. Each prism in the second structured surface has a top and a height measured from the top to the second common reference plane. The laminated film package further includes an adhesive layer disposed between the first structured surface of the first light directing film and the second smooth surface of the second light directing film. The tall but not the short prisms of the first light directing film penetrate the adhesive layer.

In another embodiment of the invention, a light management film package includes a first light directing film that includes a substrate having a thickness of less than about 50 microns, and a structured surface overlying the substrate, where the structured surface has a plurality of tall structures separated by short structures. A common reference plane is disposed between the substrate and the structured surface.

Each structure has a top and a height measured from the top to the common reference plane. The height of each tall structure is greater than the height of each short structure. The light management film package further includes a second light directing film that includes a first major surface and a second major surface opposite the first major surface. The light management film package further includes an adhesive layer disposed between the structured surface of the first light directing film and the second major surface of the second light directing film. The tall but not the short structures of the first light directing film penetrate the adhesive layer.

### BRIEF DESCRIPTION OF THE DRAWINGS

The invention may be more completely understood and appreciated in consideration of the following detailed description of various embodiments of the invention in connection with the accompanying drawings, where the drawings are not to scale and in which:

FIG. 1 is a schematic side-view of a display system;

FIG. 2 is a schematic side-view of a film laminate;

FIG. 2a is a schematic side-view of another film laminate;

FIG. 3 is a schematic side-view of another film laminate;

FIG. 4 is a plot of adhesion as a function of a distance between neighboring tall structures for various film laminates;

FIG. 5 is a plot of gain as a function of the distance between neighboring tall structures for the various film laminates of FIG. 4; and

FIG. 6 is a schematic side-view of another film laminate.

### DETAILED DESCRIPTION

The present invention is applicable to displays, such as liquid crystal displays (LCDs), and is believed to be particularly useful for hand-held LCD devices where it is desirable for the device to be thin, have high gain, and have a display area free of visible defects.

In the specification, a same reference numeral used in multiple figures refers to the same or similar elements having the same or similar properties and functionalities.

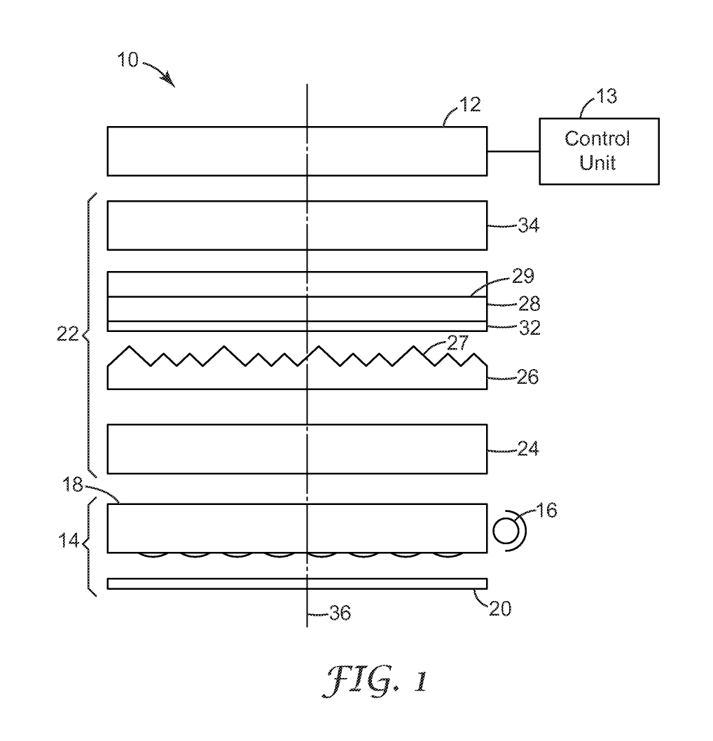

FIG. 1 is a schematic side-view of a display system 10. Display system 10 includes an electronic display unit 12, a control unit 13, a film stack 22, and a back light assembly 14 which includes a light source 16, a light guide 18, and a reflector layer(s) 20.

Display unit 12 could be a liquid crystal display (LCD) panel, which is typically sandwiched between two glass layers. Display unit 12 may include absorbing polarizers above and below the LCD panel to provide polarization contrast typically required for producing a polarization-based image. Control unit 13 controls the image displayed on display unit 12.

Back light assembly 14 is typically used for providing light through display unit 12 when there is insufficient ambient light for the user to view the image formed by display unit 12. Light guide 18 directs the light from light source 16 up through system 10 towards the display unit. Light source 16 may be any suitable type of light source. In many cases, light source 16 includes one or more fluorescent lamps.

Light management film stack 22 includes a first diffuser film 24, light directing films 26 and 28, and a reflective polarizer film 34. First diffuser film 24 is configured to make uniform the intensity of the light passing up through film stack 22.

Light directing films 26 and 28 may be structured films, as shown in FIG. 1, each having an array of linear structured elements 27 and 29, respectively, running across their upper surfaces. The structured elements may include, but are not limited to, triangular prism elements having a sharp or blunt tip. Structured elements 27 and 29 help direct the light towards axis 36 of system 10.

Films 26 and 28 may be arranged, relative to each other, such that their arrays of structured elements 27 and 29 run parallel, or more typically, non-parallel. In the embodiment of FIG. 1, structured elements 27 of film 26 are oriented perpendicular relative to structured elements 29 of film 28. In some applications, only one of films 26 and 28 may be included in system 10. In some other applications, three or more light directing films could be used.

Structured elements 27 of film 26 may include a pattern of tall prisms separated by short prisms, as shown in FIG. 1. Various patterns and the benefits of those patterns are discussed in more detail below. In the particular embodiment shown in FIG. 1, neighboring tall prisms are separated by two short prisms.

Film 26 may be adhered to film 28 via an adhesive layer 32, as shown in FIG. 1, which is disposed between a bottom surface of film 28 and the structured surface of film 26. As such, the tall prisms of structured elements 27 may penetrate adhesive layer 32, while the short prisms do not contact or penetrate adhesive layer 32.

It should be noted that, depending on a system design, some of the elements represented in film stack 22 may be missing, added to, or substituted with other functional elements. Since it is often important to reduce the thickness of stack 22 to reduce overall display thickness, individual films in film stack 22 may be made very thin. As a result, the individual film stiffness may be low, which can result in increased difficulty in handling, processing, and assembly, for example, during manufacture. Bundling various optical film layers may improve handling and final system assembly efficiency. In addition, the bundling of films may improve stiffness and result in films that are more mechanically stable.

One method of bundling optical films includes inserting an adhesive layer between each of the films to form a film laminate. The adhesive layer may lie across the entire stack from edge to edge, may be positioned along one or more edges of the stack, or may be patterned over the area of some or all of the film layers.

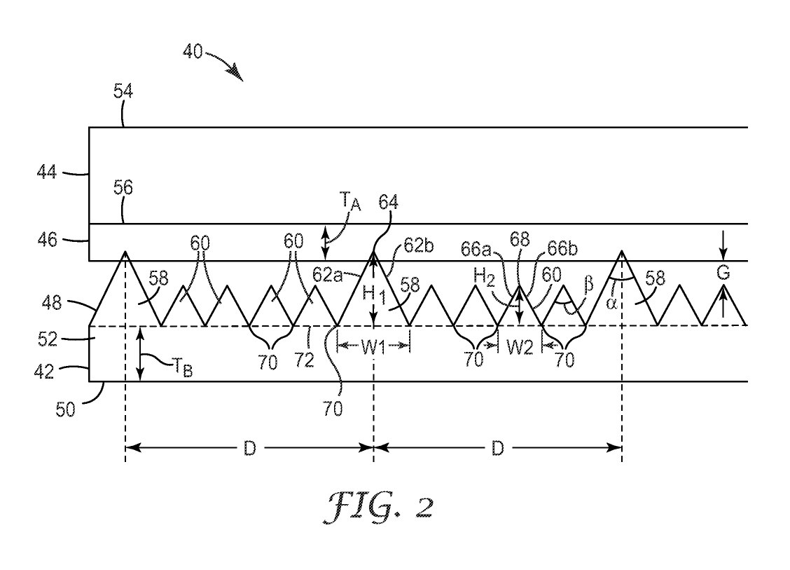

FIG. 2 is a schematic side-view of a film laminate 40 including a first film 42, a second film 44 and an adhesive layer 46. First film 42 includes a structured surface 48, an opposing second major surface 50, and a base film portion 52 disposed between structured surface 48 and opposing second major surface 50. Second film 44 includes a first major surface 54 and an opposing second major surface 56. Adhesive layer 46 is disposed between second major surface 56 of second film 44 and structured surface 48 of first film 42. As shown in FIG. 2, first major surface 54 of second film 44 is a smooth surface. In some embodiments, second film 44 may be a diffuser film or a reflective polarizer. However, it is recognized that second film 44 may also include a structured surface, for example, similar to first film 42.

Structured surface 48 includes a plurality of tall structures 58 which are separated by a plurality of short structures 60. Each tall structure 58 has a first side surface 62a and a second side surface 62b, which intersect at their top edges to form a top 64. Each short structure 60 has a first side surface 66a and a second side surface 66b, which intersect to form a top 68. Adjoining structures, whether tall or short, intersect at their bottom edges to form grooves 70, which may or may not lie in the same plane relative to one another. It is useful to define a common reference plane 72 disposed between surfaces 48 and 50 and located closest to second major surface 50 of first film 42. Reference plane 72 may also be defined as a plane located below and closest to structured surface 48 without passing through any of tall structures 58 or short structures 60. Location of the common reference plane is, at least in part, determined by a lowest groove among grooves 70.

Each tall structure 58 has a height Hi measured from top 64 to common reference plane 72. Similarly, each short structure 60 has a height H2 measured from top 68 to reference plane 72. As shown in FIG. 2, height H1 of tall structures 58 is greater than height H2 of short structures 60. Each tall structure 58 has a width W1 and each short structure 60 has a width W2, as shown in FIG. 2. The width of each structure is defined by the smallest lateral distance between the two side surfaces of the structure in a plane that includes at least one of the two grooves 70 associated with that structure.

In the exemplary embodiment of FIG. 2, all tall structures 58 have equal heights H1 and widths W1, and all short structures 60 have equal heights H2 and widths W2. In some applications, the heights and widths among tall structures and/or short structures may vary. In some applications, height H1 of a single tall structure 58 may vary down-web and height H2 of a single short structure 60 may vary down-web. In those applications, for any down-web cross-section, each tall structure 58 has a height H1 that is greater than a height H2 of each short structure 60.

Tops 64 of neighboring tall structures 58 are separated by a distance D. In the embodiment of FIG. 2, distance D is constant. However, in other embodiments, distance D may vary across structured surface 48 depending on, for example, whether there are varying heights and widths among tall structures 58 and short structures 60, and/or a varying number of short structures 60 spaced in between neighboring tall structures 58.

Each tall prism has an inclusion or apex angle α and each short prism has an inclusion angle β. In some cases, at least two tall prisms have different inclusion angles, although in some other applications, all tall prisms have the same inclusion angle. In some applications, at least two short prisms have different inclusion angles, although in some other applications, all short prisms have the same inclusion angle. In some applications, at least one tall prism has a different inclusion angle than at least one short prism. In some cases, tall and short prisms have the same inclusion angle.

Base film portion 52 has a thickness T_{B} measured from reference plane 72 to second major surface 50. Thickness T_{B} of base film portion 52 may vary depending on, for example, the particular display system in which film laminate 40 is intended to be used. In some applications, such as a display system for a television, thickness T_{B} may have a large acceptable range of values, as compared to hand-held applications, in which thickness T_{B} may be minimal. A general range for thickness T_{B} is about 1 to 510 microns. For hand-held applications, a suitable range for thickness T_{B} is about 25 to 52 microns. In some other cases, a range for thickness T_{B} can be about 1 to 15 microns. For larger display systems, a suitable range for thickness T_{B} is less than about 510 microns. In some applications, a suitable range for thickness T_{B} is from about 380 to 510 microns.

In some cases, first film 42 may be disposed on a substrate having a thickness ranging from about 25 to 510 microns, or about 25 to 52 microns, or about 1 to 15 microns. In cases where first film 42 is disposed on a substrate, thickness T_{B} in first film 42 may be minimal, including zero microns.

Structured surface 48 of first film 42 is shown in FIG. 2 as including tall prism elements and short prism elements, in which both tall and short prisms have sharp tips. Structured surface 48 need not be limited to triangular prisms, and may include, but is not limited to, truncated prisms, rounded prisms, curves such as sinusoids or paraboloids, structures having piecewise linear sides (such as prism 158b in FIG. 2a), or any other structure that may be suitable in an application.

In FIG. 2, adhesive layer 46 having an average thickness T_{A} is disposed between first film 42 and second film 44. Adhesion layer 46 is applied over second major surface 56 of second film 44. Tall structures 58 of first film 42 penetrate into adhesive layer 46 so that first film 42 adheres to second film 44. Because adhesive layer 46 is applied over essentially all of second major surface 56 of second film 44 in the embodiment illustrated in FIG. 2, first film 42 is adhered to second film 44 through full face adhesion.

Full face adhesion can generate moire and more pronounced wet out patterns. Wet out occurs when prism tips become optically coupled to an adjacent material. Wet out can reduce gain.

An advantage of the present invention is improved adhesion because of full face adhesion between adjacent films. Another advantage of the invention is that distance D is chosen so that the visibility of a wet out pattern is reduced or eliminated. Furthermore, D is selected so that any optical coupling between the two films due to adhesive layer 46 results in little or no reduction in gain.

As shown in FIG. 2, structured surface 48 of first film 42 includes tall structures 58 separated by short structures 60. Film laminate 40 is configured such that tall structures 58 penetrate into adhesive layer 46, but short structures 60 do not penetrate into adhesive layer 46. As such, a gap, such as gap G, exists between adhesive layer 46 and short structures 60. Wet out occurs where tall structures 58 contact or penetrate adhesive layer 46. As explained in greater detail below, a critical component in maximizing or improving adhesion and gain, while reducing or eliminating visible wet out, is distance D which is a spacing between neighboring tall structures 58. In the exemplary embodiment shown in FIG. 2, four short structures 60 separate two neighboring tall structures 58. In general, there can be any number of short structures or no structures between two neighboring tall structures.

Furthermore, the short structures can have any suitable shape capable of directing light in an application.

In some applications, thickness T_{A} of adhesive layer 46 may range from about 1 to 2.5 microns, depending, for example, on a composition of adhesive layer 46, distance D, and the differential between height H1 and height H2. In some applications, T_{A} can be smaller than 1 micron or larger than 2.5 microns.

In some cases, one or both of films 42 and 44 may include other layers not shown explicitly in FIG. 2. For example, films 42 and 44 may each be disposed on a substrate not shown in FIG. 2.

FIG. 2a is a schematic side-view of a film laminate 140 including a first film 142 and a second film 144. First film 142 includes a structured surface 148, an opposing second major surface 150, and a base film portion 152 disposed between structured surface 148 and second major surface 150. Second film 144 includes a first major surface 154 and an opposing second major surface 156. An adhesive layer 146 is disposed between second major surface 156 of second film 144 and structured surface 148 of first film 142.

Structured surface 148 includes a plurality of tall structures 158, such as tall structures 158a, 158b and 158c, which are separated by a plurality of short structures 160, such as short structures 160a-160j. A distance D is defined as a spacing between neighboring tall structures 158, where D can, in general, be different for different neighboring tall structures. Adjoining structures, tall and short alike, are separated by grooves 170, which, as shown in the embodiment of FIG. 2a, do not all lie in the same horizontal plane. For example, groove 170 between tall structure 158b and short structure 160d is lower than groove 170 between short structure 160d and short structure 160e. Common reference plane 172 is defined as a plane disposed between and generally parallel to surfaces 150 and 148 and located closest to second major surface 150 of first film 142. Reference plane 172 may also be defined as a plane located below and closest to structured surface 148 without passing through any of tall structures 158 or short structures 160.

Tall structures 158 have heights H1, such as heights H1a-H1c, and widths W1, such as widths W1a-W1c, as shown in FIG. 2a. Short structures 160 similarly have heights H2 and widths W2, such as heights H2a and H2d, and widths W2a and W2d, respectively. The heights and widths of the structures are measured as described above under FIG. 2. In the exemplary embodiment shown in FIG. 2a, height H1b of tall structure 158b is greater than height H1a of tall structure 158a. In general, the tall structures may have varying heights and/or widths. Similarly, short structures may have varying heights and/or widths. A tall and/or a short structure can have a blunt top. For example, tall structure 158c has a blunt top and tall structure 158b has a sharp tip.

Similarly, as shown in FIG. 2a, short structures 160 may have varying shapes. For example, structures 160f and 160g have different shapes. As also shown in the exemplary embodiment of FIG. 2a, structured surface 148 may have a varying number of short structures 160 between neighboring tall structures 158. Furthermore, distance D can vary across structured surface 148. For example, distance D between tall structures 158a and 158b is different than distance D between tall structures 158b and 158c.

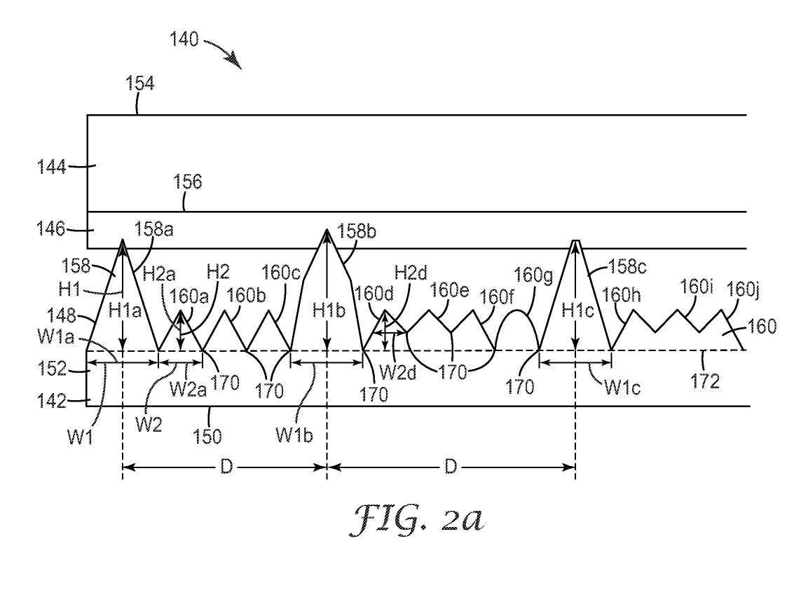

FIG. 3 is a schematic side-view of a film laminate 240 including a first film 242 and a second film 244, both having structured surfaces, and an adhesive layer 246 having an average thickness T_{A} and disposed in between first film 242 and second film 244. First film 242 includes a structured surface 248 having tall structures 258 and short structures 260 both generally extended along the z-direction, an opposing second major surface 250, and a base film portion 252 having an average thickness T_{B}. Second film 244 includes a structured surface 254 having structures 255 generally extended along the z-direction, and an opposing second major surface 256. Structured surfaces 248 and 254 are shown in parallel to one another. In general, the structures in the two films may be oriented differently relative to one another. For example, structures in structured surfaces 248 and 254 can be oriented perpendicular relative to one another.

Each tall structure 258 has a first side surface 262a and a second side surface 262b, which intersect at their top edges to form a top 264. Each short structure 260 has a first side surface 266a and a second side surface 266b, which intersect to form a top 268. Adjoining structures, tall or short, intersect at their bottom edges to form grooves 270. Common reference plane 272 is defined as a plane disposed between surfaces 248 and 250. In some applications, plane 272 is located closest to second major surface 250. In some cases, common reference plane 272 may be defined as a plane located below and closest to structured surface 248 without passing through any of structures 258 or 260.

Each tall structure 258 has a height H1 measured from top 264 to common reference plane 272; each short structure 260 has a height H2 measured from top 268 to common reference plane 272. Each tall structure 258 has a width W1 and each short structure 260 has a width W2, where widths W1 and W2 are defined as the smallest lateral distance between the two side surfaces of the structure in a plane that includes at least one of the two grooves associated with that structure.

In the exemplary embodiment shown in FIG. 3, grooves 270 lie in common reference plane 272. Accordingly, for a given tall structure, width W1 is measured from bottom edge of first side surface 262a to bottom edge of second side surface 262b of the structure; and for a given short structure, width W2 is measured from bottom edge of first side surface 266a to bottom edge of second side surface 266b of the structure. Widths W1 of tall structures 258 can be greater than, equal to or less than widths W2 of short structures 260. In the exemplary embodiment of FIG. 3, height H1 and width W1 are constant across structured surface 248; and height H2 and width W2 are constant across surface 248. In some applications, the heights and widths among the tall structures and/or among the short structures may vary.

A suitable range of values for widths W1 and W2 is about 10 to 60 microns. A suitable range of values for heights H1 and H2 is about 5 to 30 microns. It is recognized that widths W1 and W2, as well as heights H1 and H2, may be any value within a wide range. The dimensions of the structures may typically be affected by such factors as the type of display, the desired thickness of the film stack, and the thickness of the adhesive.

Each structure 255 of second film 244 has a first side surface 274a and second side surface 274b which intersect at their top edges to form a top 276. Adjoining structures 255 intersect at their bottom edges to form grooves 278. In the exemplary embodiment of FIG. 3, grooves 278 lie in a same horizontal plane defined as a second common reference plane 280, which is a horizontal plane located below and closest to structured surface 254 without passing through any of structures 255.

Each structure 255 has a height H3 measured from top 276 to common reference plane 280 and a width W3. In the exemplary embodiment shown in FIG. 3, grooves 278 lie in reference plane 280. Accordingly, width W3 can be measured from a bottom edge of first side surface 274a to a bottom edge of second side surface 274b of the same structure.

In the exemplary embodiment shown in FIG. 3, second film 244 is a thinner film, as compared to first film 242. Furthermore, height H1 of tall structures 258 of first film 242 is greater than height H3 of structures 255 of second film 244; similarly, width W1 of tall structures 258 is greater than width W3 of structures 255. In some applications, tall structures 258 and/or short structures 260, both of first film 242, are wider and/or taller than structures 255 of second film 244. In some cases, some structures in film 242 are larger than some structures in film 242, where by “larger” and “smaller” it is meant that a smaller structure can be fully enclosed within a larger structure.

As shown in FIG. 3, tall structures 258 and short structures 260 of first film 242, as well as structures 255 of second film 244, are shown as triangular prisms having a sharp tip. In general, structured surfaces 248 and 254 of films 242 and 244, respectively, may include any type of structured element. In some cases, tall structures 258 and short structures 260 may be different structures.

In the embodiment shown in FIG. 3, tall structures 258, short structures 260, and structures 255 are all isosceles right triangles. Thus an apex angle of each prism is 90 degrees. In general, a suitable range for the apex angle is from about 70 to 110 degrees.

In the embodiment shown in FIG. 3, neighboring tall structures 258 of first film 242 are separated by two short structures 260. This pattern is repeated across structured surface 248 of first film 242. Tall structures 258 contact and penetrate adhesive layer 246, whereas short structures 260 do not penetrate and/or contact adhesive layer 246.

As stated above, the present invention relates to an optimal range for distance D, where D is equal to a distance between tops of neighboring tall structures 258. In some cases, distance D may vary within structured surface 248 of film 242 (see, for example, FIG. 2a). As an example, structured surface 248 may have some tall structures 258 separated by two short structures 260 and some other tall structures 258 separated by three short structures 260.

A height differential between tall structures 258 and short structures 260 can be in a range from about 1 micron to 10 microns. In some applications, thickness T_{A} is in a range from about 1.0 to about 1.75 microns.

Forming a repeating pattern of tall structures and short structures increases gain and reduces wet out by reducing the contact area between films 242 and 244. The repeating pattern of film 242 of FIG. 3 is one tall structure, then two short structures. Other patterns of tall and short structures have also been evaluated. The table below presents those evaluated patterns, where the pattern number indicates the number of short structures placed between neighboring tall structures.

In the table below, distance D is the distance between neighboring tall structures. For each test pattern, a laminate was prepared by adhering the test pattern film to a second structured film having all prisms with an apex angle of 90 degrees and a spacing of 24 microns between adjacent prisms. Film laminate 240, as shown in FIG. 3, is similar to pattern 2 below.

| Pattern Number | Pattern Design | Distance D |
|---|---|---|
| Pattern 0 | All tall | 50 microns |
| Pattern 1 | 1 tall, 1 short | 100 microns |
| Pattern 2 | 1 tall, 2 short | 150 microns |
| Pattern 4 | 1 tall, 4 short | 250 microns |
| Pattern 6 | 1 tall, 6 short | 350 microns |

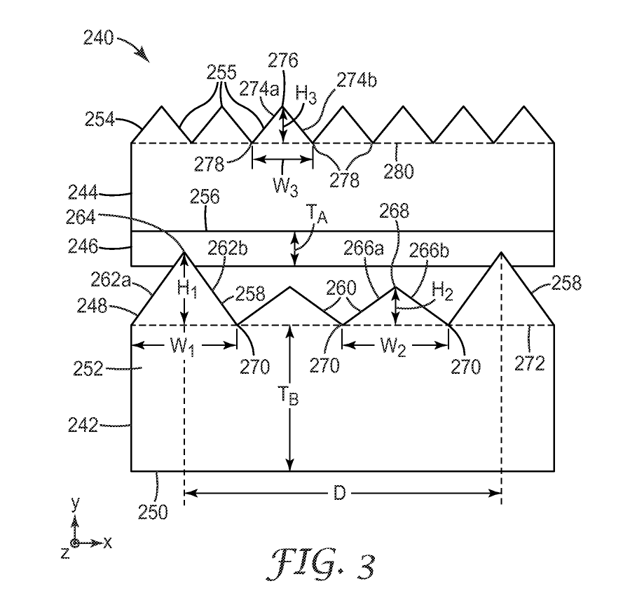

FIG. 4 is a plot of adhesion as a function of distance D for film laminates shown in the table above. Each test pattern was tested at four different adhesive thicknesses, where adhesion was measured in arbitrary units. As shown in FIG. 4, as distance D increases, adhesion tends to decrease because fewer tall structures penetrate the adhesion layer. In general, sufficient adhesion was observed for distance D between 50 and 100 microns. At distance D around 150 microns, a thicker adhesive layer improved adhesion. At distance D above 250 microns, adhesion was relatively low.

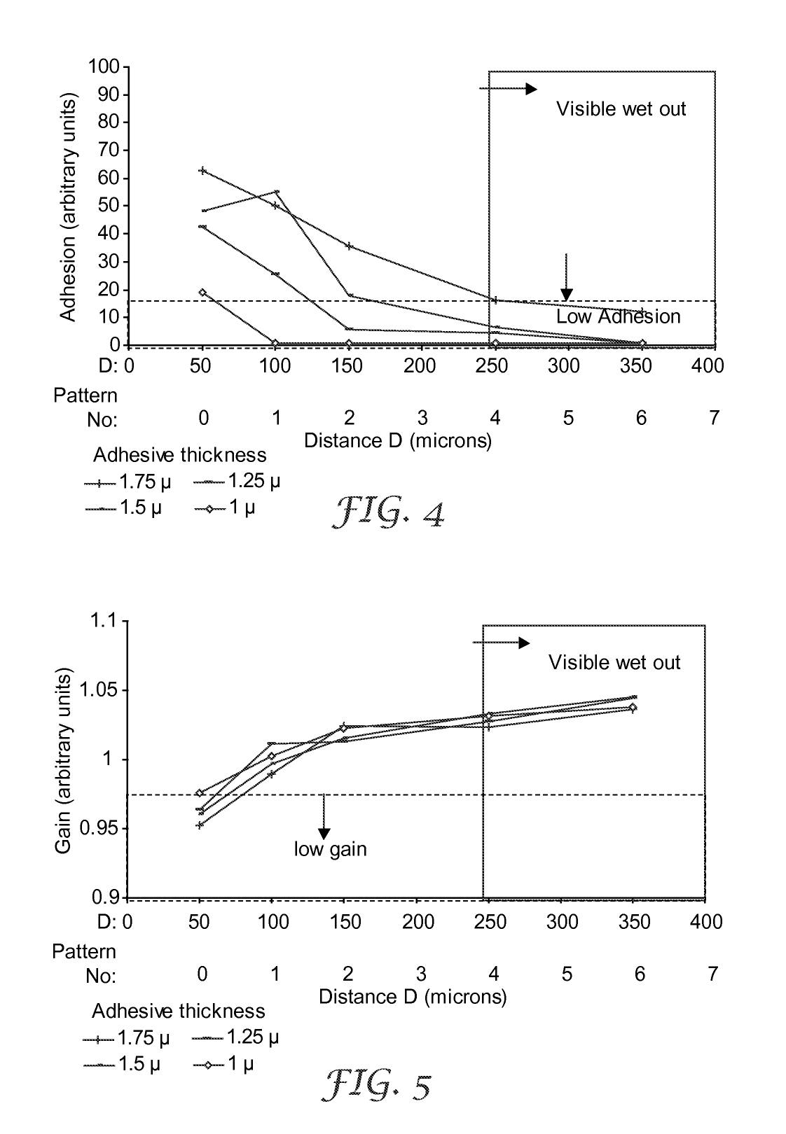

FIG. 5 is a plot of gain as a function of distance D for the film laminate samples from FIG. 4, where gain was measured in arbitrary units. As shown in FIG. 5, as distance D increases, gain increases. However, at distance D equal to approximately 250 microns, visible wet out patterns were observed. At distance D around 50 microns, low gain was observed, particularly for thicker adhesive layers. At distance D between about 100 microns and up to about 250 microns, the film laminates exhibited improved gain for all adhesive thicknesses.

Based upon data presented above, a suitable range for distance D is between about 50 and 250 microns. In some applications, a suitable range for distance D is between about 50 and 150 microns. For D greater than 250 microns, a film laminate tends to have relatively low adhesion and visible wet out patterns. For D less than about 50 microns, gain tends to be relatively low. In some applications, distance D is between about 90 and 150 microns to optimize both gain and adhesion, while minimizing or reducing visible wet out.

In addition to using patterns of tall and short structures, wet out may also be reduced by adjusting the adhesive properties of the adhesive layer. Incorporating stiffer, thinner adhesives into the design of the film laminates can further reduce wet out, while maintaining sufficient adhesion. The visibility of the wet out pattern is partly governed by the depth of penetration. Depth of penetration is a distance a tall prism penetrates the adhesive plus any distance the adhesive might have flowed along a side of the tall prism. For a soft adhesive, depth of penetration can be larger than the adhesive thickness as the adhesive may flow, for example, during assembly or with time, along the sides of a tall prism. In some applications, a stiffer and/or thinner adhesive may be used, in which case a depth of penetration may be essentially equal to the distance the prism penetrates the adhesive. In some applications, a thicker adhesive may be used, in which case a tall prism may only partially penetrate the adhesive layer.

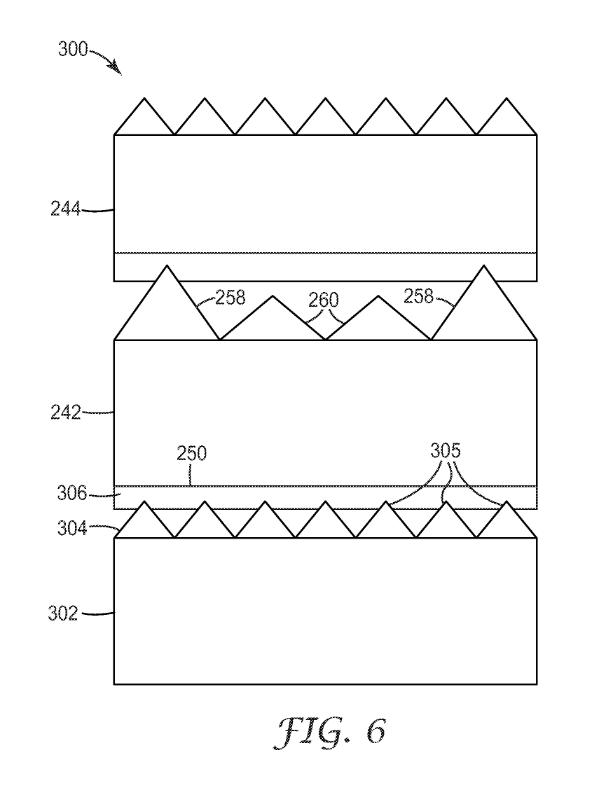

FIG. 6 is a schematic side-view of a film laminate 300 having three light directing films 242, 244 and 302. To form a film laminate having three light directing films instead of two, third film 302 may be disposed under first film 242. As shown in FIG. 6, third film 302 includes structured surface 304 having a plurality of structures 305. Adhesive layer 306 may be applied to second major surface 250 of first film 242. As shown in FIG. 6, structures 305 of third film 302 penetrate adhesive layer 306 to adhere third film 302 to first film 242. In some cases, third film 302 is thinner than first film 242 and structures 305 are smaller than structures 258 and 260 of first film 242.

In some cases, third film 302 may be designed to have a function other than brightness enhancement. For example, third film 302 may be an optical diffuser, in which case, structures 305 of structured surface 304 may function as spacers between third film 302 and first film 242.

The structured films described above are manufactured using various methods, including embossing, extrusion, casting and curing, compression molding and injection molding. One method of embossing is described in U.S. Pat. No. 6,322,236, which includes diamond turning techniques to form a patterned roll which is then used for embossing a structured surface onto a film. A similar method may be used to form the films described above having patterns of tall and short structures.

Other approaches may be followed for producing a film having a structured surface with a repeating pattern. For example, the film may be injection molded using a mold having a particular pattern thereon. The resulting injection molded film has a surface that is the complement of the pattern in the mold. In another approach, the film may be compression molded.

As used herein, terms such as “vertical”, “horizontal”, “above”, “below”, “left” and “right”, and other similar terms, refer to relative positions as shown in the figures. In general, a physical embodiment can have a different orientation, and in that case the terms are intended to refer to relative positions modified to the actual orientation of the device. For example, even if the construction in FIG. 1 is inverted as compared to the orientation in the figure, common reference plane 72 is still considered to be “below” structured surface 48.

Although the present invention has been described with reference to preferred embodiments, workers skilled in the art will recognize that changes may be made in form and detail without departing from the spirit and scope of the invention.

1. A light management film package comprising:
a first optical film having a first major structured surface with a plurality of tall structures separated by short structures and a second major surface opposite the first major structured surface, each tall structure and each short structure having a top and a height measured from the top to a first common reference plane, wherein the height of each short structure is less than the height of each tall structure, and wherein the tops of neighboring tall structures are separated by a distance of between about 50 and about 150 microns; and
a second optical film having a first major surface and a second major surface opposite the first major surface, the second major surface disposed adjacent to and making contact with the first major structured surface of the first optical film via an adhesive layer, wherein each tall structure of the first optical film penetrates the adhesive layer and the short structures of the first optical film do not penetrate the adhesive layer.

2. The light management film package of claim 1, wherein the distance between the tops of the tall structures is constant.

3. The light management film package of claim 1, wherein the distance between the tops of the tall structures is variable.

4. The light management film package of claim 1, wherein the distance between the tops of the tall structures is between about 90 and about 150 microns.

5. The light management film package of claim 1, wherein the short structures have essentially equal heights.

6. The light management film package of claim 1, wherein the first optical film has a repeating pattern of one short structure interleaved between two tall structures.

7. The light management film package of claim 1, wherein the first optical film has a repeating pattern of two short structures interleaved between two tall structures.

8. The light management film package of claim 1, wherein the tall structures are prisms.

9. The light management film package of claim 8, wherein the top of the tall structures is essentially a point.

10. The light management film package of claim 8, wherein the top of the tall structures is blunt.

11. The light management film package of claim 8, wherein at least one of the tall structures has an apex angle between about 70 and about 110 degrees.

12. The light management film package of claim 11, wherein the apex angle is about 90 degrees.

13. The light management film package of claim 1, wherein at least one of the tall structures has a piecewise linear side.

14. The light management film package of claim 1, wherein the first major surface of the second optical film is a structured surface with a plurality of structures, each structure having a top and a height measured from the top to a second common reference plane.

15. A multi-layer film laminate comprising the light management film package of claim 14 and at least one additional film layer.

16. The light management film package of claim 14, wherein the first common reference plane is closest to the first major surface of the first optical film and the second common reference plane is closest to the first major surface of the second optical film, and wherein the height of each structure of the second optical film is less than the height of each tall structure of the first optical film.

17. The light management film package of claim 14, wherein each structure of the second optical film has a width that is less than a width of each tall structure of the first optical film.

18. The light management film package of claim 1, wherein the second optical film is a diffuser.

19. The light management film package of claim 1, wherein the second optical film is a reflective polarizer.

20. The light management film package of claim 1, wherein the adhesive layer has a thickness between about 1.0 and about 2.0 microns.

21. The light management film package of claim 1, wherein the tall structures of the first optical film have a depth of penetration into the adhesive layer that is approximately equal to a thickness of the adhesive layer.

22. The light management film package of claim 1, wherein the first optical film includes a base film portion disposed between the first common reference plane and the second major surface, the base film portion having a thickness equal to about 510 microns or less.

23. The light management film package of claim 22, wherein the thickness of the base film portion is between about 375 to about 510 microns.

24. The light management film package of claim 22, wherein the thickness of the base film portion is between about 25 and about 52 microns.

25. A laminated film package comprising:
a first light directing film comprising:
a first smooth surface;
a first structured surface opposite the first smooth surface and having an array of tall prisms separated by short prisms;
a first common reference plane disposed between the first smooth surface and the first structured surface without passing through the array of tall prisms and short prisms, wherein each prism has a top and a height measured from the top to the first common reference plane, wherein the height of each tall prism is greater than the height of each short prism, and wherein a distance between the tops of each neighboring tall prisms is between about 50 and about 150 microns;
a second light directing film comprising:
a second smooth surface;
a second structured surface opposite the second smooth surface and having an array of prisms;
a second common reference plane disposed between the second smooth surface and the second structured surface without passing through the array of prisms, wherein each prism has a top and a height measured from the top to the second common reference plane; and
an adhesive layer disposed between the first structured surface of the first light directing film and the second smooth surface of the second light directing film, wherein the tall but not the short prisms of the first light directing film penetrate the adhesive layer.

26. The laminated film package of claim 25, wherein the first common reference plane is closest to the first structured surface and the second common reference plane is closest to the second structured surface, and wherein the heights of the prisms of the second light directing film are less than the heights of the tall prisms of the first light directing film.

27. The laminated film package of claim 25, wherein the prisms of the second light directing film have a width that is less than a width of the tall prisms of the first light directing film.

28. The laminated film package of claim 25, wherein the first light directing film has a repeating pattern of one short prism interleaved between two tall prisms.

29. The laminated film package of claim 25, wherein the first light directing film has a repeating pattern of two short prisms interleaved between two tall prisms.

30. The laminated film package of claim 25, wherein the distance between the tops of each tall prism of the first light directing film is between about 50 and about 150 microns.

31. The laminated film package of claim 25 further comprising a gap between the adhesive layer and each short prism of the first light directing film.

32. The laminated film package of claim 25, wherein the tall prisms of the first light directing film extend along a first direction and the prisms of the second light directing film extend along a different direction.

33. The laminated film package of claim 25 further comprising a third light directing film positioned under the first light directing film and having a third structured surface attached to an adhesive layer on a first smooth surface of the first light directing film.

34. The laminated film package of claim 25, wherein the tops of the tall prisms of the first light directing film are a sharp tip.

35. The laminated film package of claim 25, wherein the tops of the tall prisms of the first light directing film are a blunt tip.

36. A multi-layer film laminate comprising the laminated film package of claim 25 and at least one additional film layer.

37. A light management film package comprising:
a first light directing film comprising:
a substrate having a thickness of less than about 50 microns; and
a structured surface overlying the substrate, the structured surface having a plurality of tall structures separated by short structures;
a common reference plane disposed between the substrate and the structured surface, wherein each structure has a top and a height measured from the top to the common reference plane, and wherein the height of each tall structure is greater than the height of each short structure;
a second light directing film comprising:
a first major surface; and
a second major surface opposite the first major surface; and
an adhesive layer disposed between the structured surface of the first light directing film and the second major surface of the second light directing film, wherein the tall but not the short structures of the first light directing film penetrate the adhesive layer.

38. The light management film package of claim 37, wherein the tops of neighboring tall structures of the first light directing film are separated by a distance of between about 50 and about 250 microns.

39. The light management film package of claim 38, wherein the tops of neighboring tall structures are separated by a distance of between about 50 and about 150 microns.

40. The light management film package of claim 37 further comprising a gap between the adhesive layer and each short structure of the first light directing film.

41. The light management film package of claim 37, wherein the thickness of the substrate of the first light directing film is less than 40 microns.

42. The light management film package of claim 37, wherein the first major surface of the second light directing film is a structured surface.

43. The light management film package of claim 37, wherein the second light directing film is a diffuser.
